(19) United States
(12) Patent Application Publication
(10) Pub. No.: US 2026/0233481 A1
(43) Pub. Date: Aug. 13, 2026

(54) SHOE UPPER MOLDING MOLD WITH IMPROVED MOLDING QUALITY USING LOWER MOLD AND UPPER MOLD INTERPOSED STOPPER THEREBETWEEN

(71) Applicants: Heedae PARK, Busan (KR); SAM BU FINE CHEMICAL CO., LTD., Gimhae-si (KR)

(72) Inventor: Heedae PARK, Busan (KR)

(21) Appl. No.: 19/533,100

(22) Filed: Feb. 6, 2026

(30) Foreign Application Priority Data
Feb. 7, 2025 (KR) 10-2025-0015580
Mar. 17, 2025 (KR) 10-2025-0033977

(51) Int. Cl. B29D 35/00; B29D 35/12

(52) U.S. Cl. CPC B29D 35/0063; A43D 8/24; B29C 33/303; B29C 59/026; B29D 35/126; B29D 35/128; B29L 2031/505

(57) ABSTRACT

A shoe upper molding mold with improved molding quality is provided, which includes a lower mold formed with grooves for desired shape of shoe upper and guiding grooves formed on the lower body to align with the upper mold, a composite fabric attached on the lower mold; and an upper mold formed a raised portion formed with protrusions corresponding to the recessed portion of the lower mold, and guiding pins protruding at positions corresponding to the guiding grooves of the lower mold, which are fitted into the guiding grooves to align with the lower mold, and stacked on top of the lower mold to press the upper surface of the composite fabric, wherein stoppers are assembled to the guiding pins formed on the upper mold, respectively, and the pressure applied to the composite fabric by the upper and lower molds is adjusted or regulated according to the stoppers.

### CROSS-REFERENCES TO RELATED APPLICATION

The present application claims priority under 35 U.S.C. § 119 to Korean Patent Application No. 10-2025-0033977 filed on Mar. 17, 2025, in the Korean Intellectual Property Office Korean Patent Application No. 10-2025-0015580 filed on Feb. 7, 2025, in the Korean Intellectual Property Office, the disclosures of which are incorporated herein by references in their entireties.

### TECHNICAL FIELD

This invention relates to a molding mold for a shoe upper with improved molding quality, utilizing a method of interlocking concave and convex patterns. More specifically, it employs a method of pressing and molding both sides of a composite fabric by interlocking, aligning, or combining a lower mold with concave patterns and an upper mold with convex patterns, stoppers interposed therebetween. This results in the edges of the patterns being molded to a near-right-angle level, and simultaneously forming concave patterns in the areas where convex patterns are formed, thereby creating a differentiated three-dimensional structure that ensures lightweight properties of the product.

This invention relates to a molding mold for shoe uppers that improves molding quality by utilizing an aligning method of a lower mold formed intaglio patterns and an upper mold formed relief patterns, stoppers placed therebetween, where the pressure applied to aligned the upper mold and the lower mold to the press by a press machine, thereby maintaining uniform quality in terms of thickness, shape, and hardness of the product, and where multiple fixing pins are formed on the lower mold to prevent discrepancies between a printed layer and the pattern formed on the shoe upper.

### BACKGROUND OF THE INVENTION

Generally, various types of shoes, including dress shoes, athletic shoes, and hiking boots, which includes: an upper leather, i.e., a shoe upper, that forms the outer appearance of the shoe, an outsole that contacts the ground, a midsole installed above the outsole, and an insole that contacts the sole of the foot. The outsole, midsole, and insole work together to protect the foot and ensure comfortable walking, while the upper leather protects the top of the foot and adds design elements to enhance the shoe's marketability.

Accordingly, continuous efforts have been made to improve the quality and productivity of shoe uppers. However, since shoe uppers mostly use conventional 2D materials such as fabrics, films, and synthetic leather, they are manufactured through multi-step processes involving no-sewing or sewing, resulting in complex processes and making it difficult to produce products with the desired level of three-dimensionality.

For example, in the past, to produce a 3D upper, a method of repeatedly stacking dyed ink to form a thickness was used, or a method of using PU liquid resin, or a PU casting method was used to create a three-dimensional shape by injecting it into a mold, or a method of injecting elastic resins such as TPU into the mold and using compression molding was used. This conventional method has poor workability due to complex process conditions and reveals limitations in improving product quality, so many problems have been raised due to expanded application.

As related art related to the shoe upper molding method described above, Korean Patent No. 10-1768978 discloses a method for manufacturing a shoe upper using a two-layer film, comprising: a first step of manufacturing a mold including irregularities in the inner space; a second step of manufacturing a two-layer film transfer by forming a printing layer and a coating layer including polyurethane; a third step of arranging the two-layer film transfer fixed to the mold so that it is positioned in the upward direction; a fourth step of forming a transfer recipient by injecting liquid or solid thermoplastic polyurethane; a fifth step of fixing the fabric to the transfer recipient, and then simultaneously pressing and heating the two-layer film transfer, the transfer recipient, and the fabric to perform injection molding; and a sixth step of processing the injection-molded two-layer film transfer, transfer recipient, and fabric to manufacture a shoe. This method has the advantage of protecting the transferred image and the fabric by manufacturing the shoe with the two-layer film, on which the shoe logo and design are transferred, attached to the fabric.

In addition, Korean Patent No. 10-1098941 discloses an upper for a shoe part formed as an integral part with the upper, which is injection-molded by injection molding synthetic resin using an injection molding machine, thereby simplifying the manufacturing process by a seamless injection molding method, and wherein the upper is spread on a lower mold of a mold, and then injection-molded using an upper mold having a desired shape engraved thereon, thereby forming the upper for a shoe part formed as an integral part with the upper, and a manufacturing method thereof. This molding method has the advantage of being simple to manufacture using a seamless injection molding method, resulting in high productivity and low defect rates, as well as the ability to easily form various patterns or complex patterns on the upper in an integrated manner.

And as a related art related to a molding device for manufacturing a shoe upper, Republic of Korea Utility Model Registration No. 20-0244339 discloses a shoe upper molding machine in which an air passage is provided inside an upper mold that moves vertically by the operation of a cylinder, a pad having a plurality of holes is mounted to seal the passage along the inside, a banding device is mounted to band the bottom joint of the shoe upper while the legs on both sides move vertically toward the rear of the upper mold, and a stopper is provided at the rear of the lower mold that fixes the shoe upper and has a cooling means inside, and a fixing plate moves back and forth by the operation of a cylinder. This increases the cooling effect and enables the shoe upper to be molded with consistent and accurate dimensions, Additionally, the sole joint at the bottom of the shoe is formed simultaneously, reducing the overall number of processes and improving productivity.

Meanwhile, shoe uppers may incorporate patterns such as vamp, side stripes, side reinforcements, product or brand names, and manufacturer's logos for visual appeal and product protection. This invention aims to propose technology for forming high-quality 3D designs on shoe uppers, departing from conventional inefficient methods that involve pressing only the upper surface of the fabric or layering printing ink multiple times to create 3D patterns. The shoe upper produced according to aspects of the present invention not only has excellent visual effects but also forms a lightweight and differentiated three-dimensional structure compared to conventional existing products.

### RELATED ART DOCUMENT

### [Patent Document]

(Patent Document 0001) Korean Patent Publication No. 10-1768978 (Published: Aug. 17, 2017).
(Patent Document 0002) Korean Patent Publication No. 10-1098941 (Published: Dec. 28, 2011).
(Patent Document 0003) Korean Utility Model Publication No. 20-0244339 (Published: Oct. 15, 2001).

### CONTENTS OF THE INVENTION

### Problems to be Solved

The objective of the present invention is to provide a shoe upper molding mold with improved molding quality using a method of aligning using guiding pins and corresponding grooves formed on a lower and an upper mold, and pressing of intaglio and relief patterns of a lower mold and upper mold with stoppers attached on the upper mold while interposing therebetween. This is achieved by employing a method of pressing and shaping both sides of a composite fabric by aligning a lower mold with intaglio patterns and an upper mold with relief patterns, thereby enabling the rapid and precise molding of complex patterns while producing a shoe upper that is lighter and softer than conventional designs.

Another objective of the present invention is to improve the method of controlling the pressure applied to the upper and lower molds using only the pressure of a conventional press machine. By setting a predetermined gap, i.e., a distance, between the upper and lower molds using the thickness of a stopper formed on or attached the upper mold, the pressure applied to the upper and lower molds in the press machine is adjusted or regulated, thereby enabling the production of shoe uppers with uniform quality in terms of thickness, shape, and hardness. Furthermore, by forming multiple fixing pins on the lower mold, it is possible to produce high-quality shoe uppers without any discrepancies between the printed layer and the pattern formed on the upper. An aspect of the present invention provides a molding mold for shoe uppers with improved molding quality by utilizing stoppers interposing between an upper molding and a lower molding for molding intaglio and relief, i.e., recessed and raised patterns in a molding mold for a shoe upper.

### Means for Solving the Problems

To achieve the above objectives, the present invention proposes a molding mold for shoe uppers with improved molding quality pressing and a lower mold with recessed portions and an upper mold with raised portions, comprising: a lower mold 10 having a lower body 11 that predetermined width, length, and height, a recessed portion 12 formed in the same shape and at a corresponding position to the outer shape and pattern of the composite fabric 1 within the plane allowed by the lower body 11, and guiding grooves 13 formed as through-holes at positions adjacent to the edges within the plane of the lower body 11 to align the upper mold 20; and an upper mold 20 having an upper body 21 that predetermined width, length, and height, a raised portion 22 with multiple protrusions corresponding to the recessed portions 12 of the lower mold 10 within the plane allowed by the upper body 21, i.e., formed on the upper body 21 and guiding pins 23 formed as protrusions at positions corresponding to the guiding grooves 13 of the lower mold 10, which are fitted into the guiding grooves 13 of the lower mold 10 to align with the lower mold 10, wherein the upper mold 20 is stacked on top of the lower mold 10 to press the upper surface of the composite fabric 1; and a stopper 100 assembled to each of the guiding pins 23 of the upper mold 20, and the pressure applied to the composite fabric 1 by the upper and lower molds 10, 20 is adjusted according to the thickness of the stopper 100.

According to an embodiment of the present invention, the stopper 100 further includes an opening 101 on one side to facilitate engagement with the guiding pin 23, and the lower mold 10 has a plurality of fixing pins 15 formed thereon to secure the seated composite fabric 1 in place, and the upper mold 20 has fixing grooves 25 formed at positions corresponding to the fixing pins 15, respectively.

Furthermore, the number of fixing pins 15 formed on the lower mold 10 and the number of fixing grooves 25 formed on the upper mold 20 are in a range of 5 to 20, respectively, and the fixing pins 15 are conical in shape. However, it is not limited thereto. The number of fixing pins is the same number of grooves due to assembling each other.

Furthermore, the lower mold 10 has the grip helping portion 18 formed inwardly in an arched shape on both sides thereof, and the lower mold 10 and the upper mold 20 are made of aluminum or epoxy resin to reduce manufacturing costs, ensure lightweight construction, and facilitate heat conduction during molding.

### Effects of the Invention

According to an embodiment of the present invention, which utilizes stoppers interposing an upper molding and a lower molding for molding intaglio and relief, i.e., recessed and raised patterns in a molding mold for a shoe upper to improve molding quality, simply placing a composite fabric between the lower and upper molds and applying pressure vertically allows for the formation of patterns and the application of various colors to the shoe upper, maximizing or improving convenience and efficiency in the manufacturing process. Furthermore, it enables the mass production of high-quality, lightweight shoe uppers in a short period of time.

Furthermore, unlike conventional methods that involve layering printing inks multiple times, an aspect of the present invention allows for precise molding of intaglio and relief patterns on the shoe upper material by applying pressure to the lower and upper molds. This results in sharp, well-defined edges in the upper material pattern, improving or maximizing the 3D effect and allowing for the application of various vibrant colors. This not only reduces the amount of printing ink used but also contributes to significant cost savings in production of the shoe upper.

Furthermore, the present invention improves upon conventional methods that control the pressure applied to an upper mold and a lower mold solely through the press machine's pressure. During the mold fitting step of the upper mold and the lower mold, the predetermined gap between the upper and lower molds is set by the thickness of the stopper inserted into the guiding pin formed on the upper mold. This regulates the pressure applied to the upper and lower molds by the press machine, enabling the production of upper molds with uniform thickness, shape, and hardness, thereby minimizing defect rates and enabling the production of high-quality shoe uppers. Furthermore, while maintaining constant press machine pressure, adjusting the stopper thickness allows for the production of high-quality shoe uppers under various molding conditions.

Furthermore, an aspect of the present invention has the effect of securely fixing the composite fabric during the molding process by forming multiple fixing pins on the lower mold, thereby preventing misalignment or unevenness in the printed layer and pattern formed on the upper part of the shoe, resulting in precise molding and enabling the creation of the desired upper shape.

Furthermore, because the lower and upper molds of this invention are made of aluminum or epoxy resin, they are lightweight, reducing worker fatigue, and allow for precise molding of intaglio and relief patterns on the mold. This results in sharp, well-defined edges in the shoe upper pattern, maximizing the 3D effect.

### BRIEF DESCRIPTION OF THE DRAWINGS

FIG. 1 is a schematic diagram showing the shoe upper molding mold proposed by the present invention mounted on a conventional press device.

FIG. 2 is a schematic diagram of the shoe upper molding mold proposed by the present invention.

FIG. 3 is a cross-sectional view showing the structure of a conventional composite fabric.

FIG. 4 is a perspective view of the lower mold according to an aspect of the present invention.

FIG. 5 is a perspective view of the upper mold according to an aspect of the present invention.

FIG. 6 is a cross-sectional view of the pattern area of a typical shoe upper.

FIG. 7 is an exemplary perspective view of a shoe upper manufactured by the molding mold according to an aspect of the present invention.

FIG. 8 is a cross-sectional view showing a shape in which the pattern of the shoe upper according to an aspect of the present invention is formed and the state in which the upper mold and the lower mold are pressed.

FIGS. 9a and 9b are exemplary diagrams comparing shoe uppers molded with and without the fixing pins of the present invention, respectively.

### DETAILED EMBODIMENTS

Hereafter, with reference to the attached drawings, we will explain a molding mold for a shoe upper with improved molding quality by utilizing an aligning method of a lower mold formed recessed patterns and an upper mold formed raised patterns, stoppers placed therebetween, where the pressure applied to aligned the upper mold and the lower mold to the press by a press machine, but this is intended to illustrate to the extent that a person with ordinary knowledge in the technical field to which the present invention belongs can easily carry out the invention, and this does not mean that the technical idea and category of the present invention are limited.

The terms first, second, and the like may be simply used for description of various constituent element, but those constituent elements are not limited by the terms. The above terms are used only for distinguishing one constituent element from the other constituent elements.

The present invention relates to a mold for forming shoe uppers with improved forming quality, utilizing an aligning method of concave and convex molds used to engrave patterns onto shoe uppers. In this invention, by employing a method where an upper mold and a lower mold, each formed with concave, i.e., recessed portion and convex patterns, i.e., raised portion, respectively, are aligned to press and mold both sides of the fabric, the pattern edges are molded to a level close to right angles, resulting in an exceptionally outstanding three-dimensional effect. Furthermore, since concave patterns are simultaneously formed in the areas where convex patterns are formed, the product achieves lightweight properties. This differentiated three-dimensional structure maximizes convenience and efficiency in use. The invention is related to developing a mold for forming shoe uppers with improved molding quality by utilizing pressing method of concave and convex patterns using stoppers interposed between the upper mold and the lower mold.

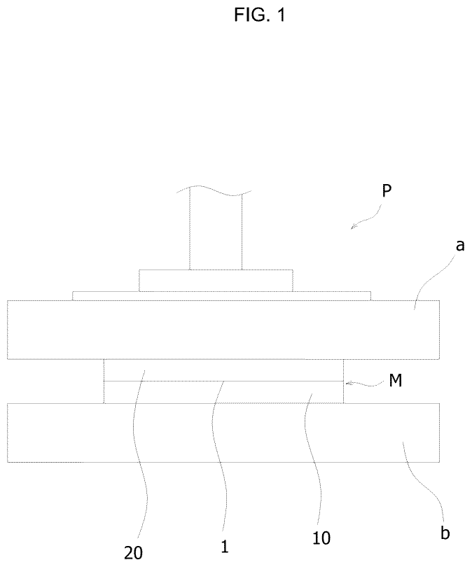

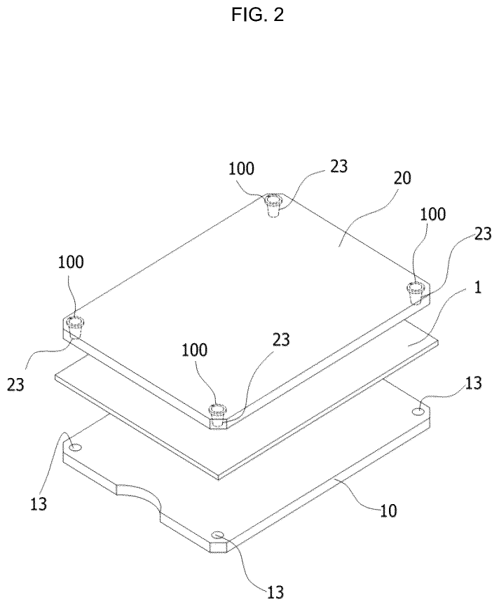

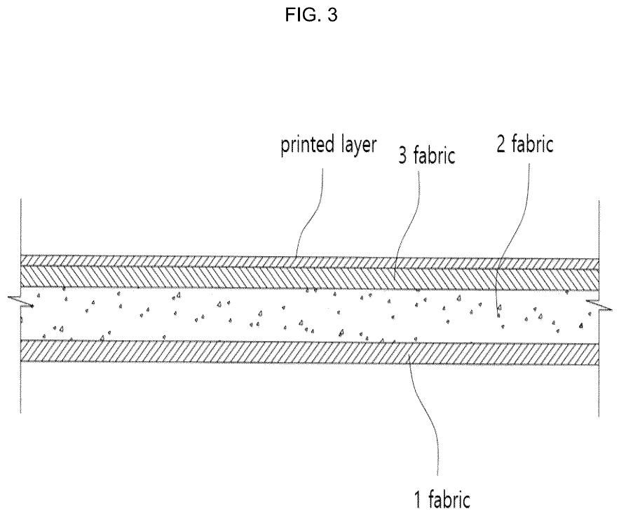

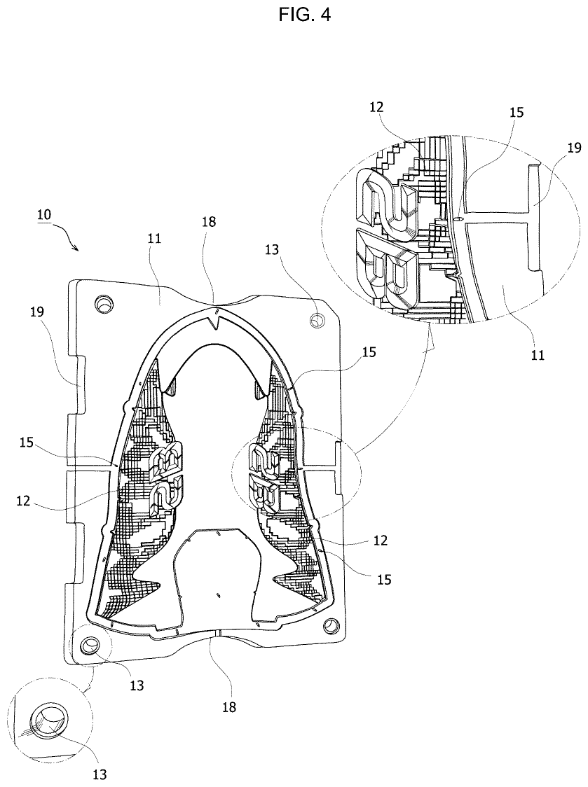

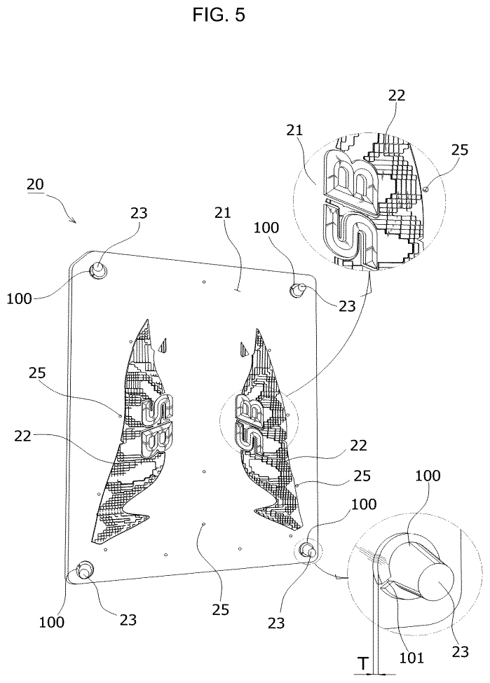

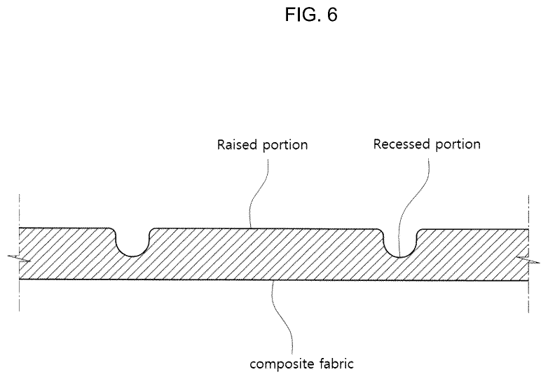

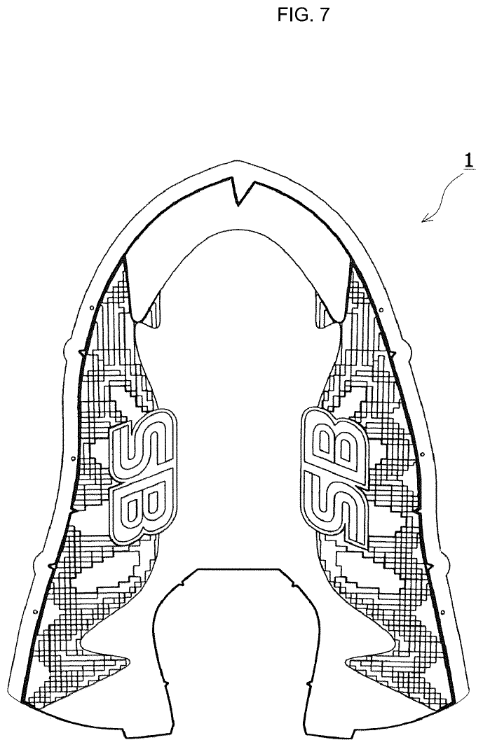

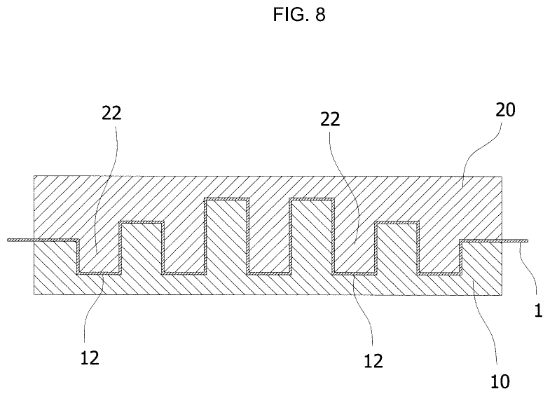

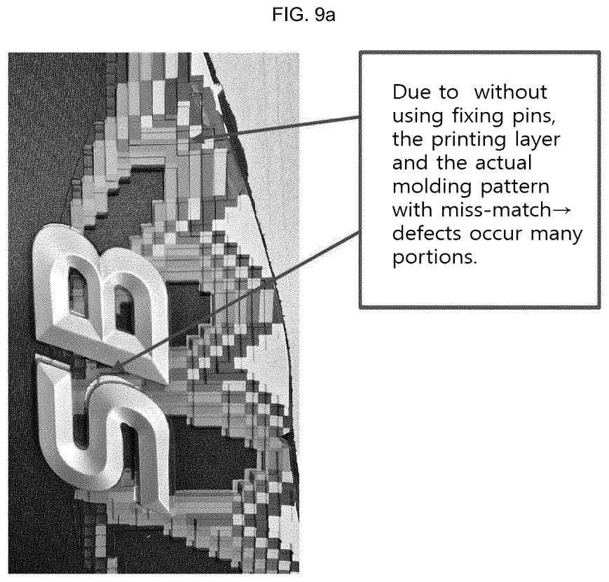

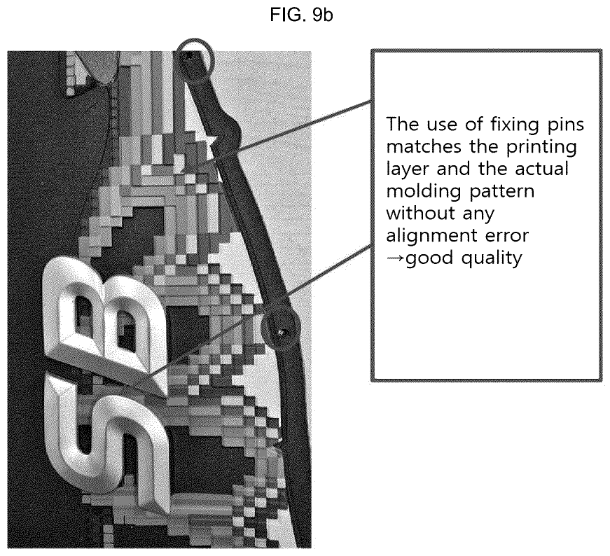

FIG. 1 is a schematic diagram showing the shoe upper molding mold according to an aspect of the present invention mounted on a conventional press device. FIG. 2 is a schematic diagram of the shoe upper molding mold according to an aspect of the present invention. FIG. 3 is a cross-sectional view of a conventional composite fabric. FIG. 4 is a perspective view of the lower mold according to an aspect of the present invention. FIG. 5 is a perspective view of the upper mold according to an aspect of the present invention. FIG. 6 is a cross-sectional view of the pattern area of a typical shoe upper. FIG. 7 is a perspective view of a shoe upper manufactured by the molding mold according to an aspect of the present invention. FIG. 8 is a cross-sectional view showing the pattern formation of the shoe upper according to an aspect of the present invention and the pressed state of the upper and lower molds. FIGS. 9a and 9b are diagrams comparing shoe uppers molded with and without the fixing pins according to an aspect of the present invention.

The composite fabric 1 is a foam package consisting of foam and a textile, specifically, wherein the first fabric composed of textile, the second fabric composed of foam, and the third fabric composed of textile are sequentially stacked, and a printing layer is formed on the upper surface of the third fabric. The material of the foam is not only polyurethane foam, which is commonly used, but also various types of foam sheets manufactured using synthetic resin or natural resin that can be effectively used for shoe uppers. On the one hand, such a foam package consists of a printed layer coated with dye, preferably on the surface of the textile, formed in various colors and designs.

The composite fabric 1 is a foam package consisting of foam and a textile, specifically, wherein the first fabric composed of textile, the second fabric composed of foam, and the third fabric composed of textile are sequentially stacked, and a printing layer is formed on the upper surface of the third fabric. The material of the foam is not only polyurethane foam, which is commonly used, but also various types of foam sheets manufactured using synthetic resin or natural resin that can be effectively used for shoe uppers. On the one hand, such a foam package consists of a printed layer coated with dye, preferably on the surface of the textile, formed in various colors and designs.

FIG. 4 is a perspective view showing the configuration of the lower mold 10 proposed by the present invention. Referring to FIG. 4, the lower mold 10 of the present invention has an engraved pattern corresponding to the outer shape and pattern of the product formed on a flat surface of a predetermined width and accommodates the composite fabric 1 on the flat surface where the engraved pattern is formed. However, it is understood that the surface of the lower mold may not be flat.

The lower mold 10 is composed of a lower body 11 that may be flat with a predetermined width, and an engraved portion, i.e., an recessed portion 12 formed in the same shape and at a corresponding position to the outer shape and pattern of the composite fabric 1 within the plane allowed by the lower body 11.

The lower body 11 is in the shape of a rectangular, a square, or other shaped outer form with a predetermined thickness, and is configured with a sufficiently wide area to accommodate the composite fabric 1 for the shoe upper. Both the upper and lower surfaces may be flat, allowing them to be stably mounted on a conventional press device (P) as shown in FIG. 1, thereby easily accommodating the composite fabric 1.

The recessed portion 12 formed in the lower body 11 consists of a plurality of grooves arranged within the area permitted by the upper surface of the lower body 11. The shape of these grooves corresponds to patterns, designs, brand names, logos, etc., formed on the shoe upper, primarily in the form of a main pattern shaped like a “U” as shown in FIG. 7, or an upper edge pattern, ankle pattern, or shoelace hole pattern formed with a predetermined width along the edges of the main pattern, mainly in the areas of both sides of the foot, toes, and instep.

The lower mold 10, which has guiding grooves 13 formed in a form of through-holes or buried holes at positions adjacent to the edges within the plane of the lower body 11, configured to align the upper mold 20 shown in FIG. 5. These guiding grooving 13 guide the guide pins 23 of the upper mold 20, which will be described later, to ensure that the upper mold 20 and the lower mold 10 are stacked in the correct position. Therefore, the guiding grooves 13 and the guiding pins 23 are made with corresponding diameters.

FIG. 5 is a perspective view showing the configuration of the upper mold 20 according to an aspect of the present invention. Referring to FIG. 5, the upper mold 20 of an aspect of the present invention has raised portions formed on a flat surface of a predetermined width, at positions corresponding to the recessed portions of the lower mold 10. As shown in FIG. 2 or FIG. 8, the upper mold is stacked on top of the lower mold 10 and pressed down on the upper surface of the composite fabric 1.

The upper mold 20 is composed of an upper body 21 that may be flat with a predetermined width, and a raised portion 22 formed with multiple protrusions corresponding to the recessed portions 12 of the lower mold 10 within the plane allowed by the upper body 21. In other word, i.e., the raised portion 22 formed with multiple protrusions corresponding to the recessed portions 12 of the lower mold 10 formed on the upper body 21.

The upper body 21 may be in the shape of a rectangular, a square, or other shape with a predetermined thickness, preferably the same shape as the lower body 11, and may be configured with a sufficiently generous width to uniformly press the entire surface of the composite fabric 1 for the shoe upper. It is preferable that the upper body 20 may have both upper and lower surfaces that may be flat so that the entire surface of the composite fabric 1 can be uniformly pressed by the press device (P) shown in FIG. 1. However, the surface of upper mold and the surface of the lower mold may be varied according to the pattern of the object to be formed.

The raised portions 22 formed on the upper body 21 has at least one protrusion formed within the range permitted by the bottom surface of the upper mold 20. The raised portions 22 can be formed at a position corresponding one-to-one (1:1) with the recessed portions 12 of the lower mold 10 shown in FIG. 4, which can be formed in a slightly smaller size than the recessed portions 12 so that it can be closely fitted into the recessed portions 12.

According to an embodiment of the present invention, the raised portion 22 is formed by a plurality of very small pillars protruding to form a cluster, that is, a design. Here, “design” refers to the pattern, design, brand name, logo, etc., of the shoe upper, and can be composed of an arrangement in the shape of a “U” as shown in FIG. 7.

In other words, the raised portion 22 may be formed as a protruding rectangular column, and depending on the design, it may be a cluster design with cylindrical, triangular, polygonal columns, cones, triangular pyramids, etc., arranged, or it may be a single design such as stripes, text, or a brand logo. However it is not limited thereto.

Meanwhile, the conventional method of forming shoe uppers, as shown in FIG. 6 the conventional shoe upper molding method, as shown in FIG. 6, was a method of placing a composite fabric on a flat surface and applying high frequency to the upper surface of the composite fabric to partially create a 3D effect. However, this molding method simply creates indentations on the surface of the composite fabric to obtain a pattern, making it impossible to obtain raised patterns that protrude beyond the surface of the composite fabric. Furthermore, the three-dimensional effect of the raised patterns is poor, and the boundary between the indented and raised parts is inevitably formed in a rounded shape, resulting in very low clarity of the upper pattern, which causes problems with the product quality.

In contrast, as shown in FIGS. 7 and 8, an aspect of the present invention may allow the raised portion 22 of the upper mold 20 to press down on the upper surface of the composite fabric 1 and push it into the recessed portion 12 of the lower mold 10, simultaneously forming both raised and indented patterns at the same location on the composite fabric 1, thereby achieving a clearer 3D effect. In particular, the edges of the upper pattern can be processed to a level close to a right angle, resulting in a precise and highly defined pattern.

Therefore, the molding method using a molding mold for the shoe upper of the present invention can not only mold very fine patterns, but also accurately mold complex and diverse designs regardless of the spacing between patterns.

As shown in FIG. 4 and FIG. 5, the upper mold 20 having upper body 21 with a predetermined width, length, and height, and a guiding pin 23 is formed protruding from each corner in the plane of the upper body 21 and is fitted into corresponding guiding groove 13 of the lower mold 10, and the guiding pin 23 is formed at a position adjacent to each corner of the upper mold 20, which is arranged on a vertical line corresponding to the position corresponding to the guiding groove 13 of the lower mold 10 if the upper and lower molds 10, 20 are stacked above and below the lower mold 10 and the upper mold 20. More guiding pins and guiding groove may be further prepared if required. The guiding groove may be a buried hole or a through hole. However, it is not limited to, it can be any kind of shape as long as the guiding groove can receive the guiding pin.

The guiding pins 23 of the upper mold 20 into corresponding the guiding grooves 13 of the lower mold 10, respectively, and may play the role of vertically aligning, stacking up, or folding the upper mold 20 with the lower mold 10. The guiding grooves 13 and the guiding pins 23 are made with corresponding diameters so that the guiding pins can be inserted into the corresponding guiding grooves, respectively.

The guiding pins 23 are shown in the enlarged drawing of FIG. 5, even if the end of the lower mold 10 and the upper mold 20 are not in an accurate vertical position, if the end of the guiding pin 23 is located only within the inner diameter allowed by the guiding groove 13, the lower mold 10 and the upper mold 20 may be easily stacked up, aligned, or folded in the correct position as guiding pins 23 may be inserted into the guiding grooves 13 easily by the taper.

Meanwhile, a stopper 100 is assembled onto each guiding pin 23 formed on each 4 corners of the upper mold 20, and the gap between the upper and lower molds 10, 20 is set according to thickness T of the stoppers 100, thereby allowing the pressure applied to the composite fabric 1 by the upper and lower molds 10, 20 to be adjusted or regulated. In particular, one or more stoppers 100 may be assembled onto each guiding pin 23, and the stopper(s) may serve to maintain a consistent thickness of the shoe upper with different thickness of the shoe upper. In other words, a typical composite fabric 1, as shown in FIG. 3, consists of textiles on the top and bottom with foam in between. However, because the foam does not have a uniform thickness during the skiving process, for example, when skiving a foam block to a thickness of 4 mm, the entire surface of the foam is not cut uniformly to exactly 4 mm, but rather variations such as 4.2 mm, 4.1 mm, 4.4 mm, etc., occur, if molding is performed without using a stopper 100, thickness variations will occur on the product surface. To prevent this, an aspect of the present invention may use stoppers 100, during molding process, the stoppers causes the thicker parts of the foam to be compressed more, while the parts with uniform thickness are compressed normally, resulting in a finished product with a consistent overall thickness.

As described above, aspect(s) of the present invention may improve upon the conventional method of controlling the pressure applied to the upper and lower molds 10, 20 of a typical press device (P) solely through hydraulic or pneumatic systems. By setting a gap between the upper and lower molds 10, 20 using a predetermined thickness of the stopper 100, the pressure applied to the upper and lower molds 10, 20 in the press device (P) can be adjusted. This allows for uniform molding of the thickness, shape, and/or hardness of the composite material 1, minimizing or reducing product defects and enabling the production of uppers with various thicknesses and hardness levels. For example, a pressure applied to the upper and lower molds 10, 20 by the press device (P) can be higher if thicker stoppers are used than thinner stoppers.

In addition, since thickness and a hardness of the shoe upper may be be varied according to the product requirements, conventional methods involved preparing molds of various specifications or adjusting the pressure or temperature of the press device (P), which has been a factor in increasing product defect rates.

According to aspect of the present invention, by maintaining a constant pressure of the press device (P) and adjusting the thickness of the stopper 100, using different number of stopper and/or using different thickness of stopper 100, high-quality shoe uppers can be produced under various molding conditions. By using a different thickness of the stopper, different kinds of shoe uppers having different thickness can be produced.

The stopper 100 can be manufactured with a predetermined different thickness according to an aspect of the present invention. But if more than one stopper is inserted into a guiding pin to achieve a desired different thickness of shoe upper, different thickness of shoe upper may be produced. But it is also possible to use different thickness of the stopper 100 to produce different thickness of shoe upper for convenience during operation. According to an aspect of the present invention, considering the molding conditions of various products, the thickness of the stopper 100 may be formed in a range of 0.5 to 2.0 mm.

The reason for this is that when the thickness of the stopper 100 is less than 0.5 mm, the pressure applied to the upper and lower molds 10, 20 through the press device (P) is transmitted too strongly, making it difficult to control the hardness and thickness of the shoe upper formed from the composite fabric 1. Conversely, when the thickness of the stopper 100 exceeds 2.0 mm, the gap between the upper and lower molds 10, 20 becomes excessively large, resulting in insufficient pressure being transmitted to the composite fabric 1, leading to incomplete molding of the upper part of the shoe or uneven shape stability. However, the thickness of the stopper may be used for producing a different thickness of a shoe upper.

Meanwhile, as shown in the enlarged view of FIG. 5, the stopper 100 is further configured with an opening 101 on one side to facilitate coupling with the guiding pin 23, thereby allowing the stopper 100 to be firmly fixed to the guiding pin 23. Furthermore, it is essential that the inner diameter of the stopper 100 precisely matches the outer diameter of the guiding pin 23 to prevent it from becoming detached during operation.

More specifically, by widening or spreading the opening 101 of the stopper 100 to accommodate the guiding pin 23 and then restoring the opening 101 to its original position, the stopper 100 is press-fitted onto the guiding pin 23, resulting in a secure connection with the guiding pin 23.

For this purpose, it is preferable that the stopper 100 be made of metal material that can withstand the temperature and pressure applied to the upper and lower molds 10 and 20 while having a certain degree of elasticity, which has the effect of maximizing the convenience and productivity of the operator by preventing the composite fabric 1 from deviating from the guiding pin 100 even in the molding process by firmly fixing the stopper 100 to the bottom of the guiding pin 23.

Furthermore, as shown in FIGS. 4 and 5, the lower mold 10 is formed with a plurality of fixing pins 15 to secure the seated composite fabric 1 and prevent it from moving, and the upper mold 20 is formed with fixing grooves 25 at positions corresponding to the fixing pins 15. The fixing grooves may be in shape of buried holes or through holes. By forming the fixing pins 15 and fixing grooves 25 on the upper and lower molds 10, 20, respectively, as shown in FIGS. 7 and 9b, the printed layer of the composite fabric 1 and the actual molded thickness difference can be precisely matched one-to-one (1:1). That is, by precisely matching the ink gradation and height gradation of the printed layer one-to-one (1:1) as shown in FIG. 9b, it is possible to prevent the ink from the printed layer from spreading to other areas, specifically, the problem shown in FIG. 9a, where the ink gradation and height gradation overlap.

This allows the fixing pins 15 to firmly secure the composite fabric 1 during the molding process. To improve or maximize this effect, it is preferable to have 5 to 20 fixing pins 15 and corresponding fixing grooves 25, which are formed along with an edge and central part of the composite fabric 1 as shown in FIGS. 4 and 5. According to an aspect of the present invention, it is desirable to have multiple fixing pins 15 and fixing grooves 25 because if there are no fixing pins or only a small number of fixing pins 15 and fixing grooves 25, the composite fabric 1 will shrink due to heat during the molding process. This results in a mismatch between the ink gradation and height gradation, as shown in FIG. 9a. Therefore, to solve this problem, according to an aspect of the present invention may utilize 5 to 20 fixing pins 15 and fixing grooves 25, respectively, preferably thirteen fixing pins 15 and fixing grooves 25, respectively, to prevent shrinkage of the composite fabric 1 during the molding process. composite fabric 1.

The fixing pins 15 formed on the lower mold 10 may be conical in shape, which facilitates smooth engagement with the fixing grooves 25 formed in the upper mold 20. This prevents the problem of the printed layer color and design demarcation lines of the completed composite fabric 1 being misaligned with the actual step difference of the upper product, thereby enabling the realization of a high-quality product shape.

As shown in FIGS. 4 and 5, thirteen fixing pins 15 are formed on the lower mold 10, and thirteen fixing grooves 25 are formed on the upper mold 20 at positions corresponding to the fixing pins 15 according to an aspect of the present invention. However, the number of fixing pins and the number of fixing grooves may be varied according to size or shape of the shoe upper.

In addition, as shown in FIGS. 2 and 4, an arched grip helping portion 18 may be formed on both sides of the lower mold 10. When the processing of the composite fabric 1 is completed with the upper mold 20 stacked on the lower mold 10, the worker can easily separate the upper mold 20 from the lower mold 10 by grasping only the upper mold 20 through the grip helping portion 18.

In addition, a plurality of supporting portions 19 in a straight line groove form are formed on the outer border of the lower mold 10, and the supporting portion 19 plays a role in separating the upper mold 20 from the lower mold 10 by intervening the lever at the position where the supporting portion 19 is formed in the state where the lower mold 10 and the upper mold 20 are stacked, and the supporting portion 19 is used as a support to induce the operation of the lever.

Furthermore, the molding die for shoe uppers proposed in this invention can be made of aluminum or epoxy resin for the lower mold 10 and upper mold 20 to reduce manufacturing costs, achieve lightweight properties, and improve thermal conductivity during product molding. Compared to steel, these materials offer superior moldability, allowing for precise engraving of recessed portions 12 and raised portions 22 in each mold, thereby significantly improving design quality. In addition, the lower material cost reduces the cost of manufacturing the molds, and their lighter weight and higher thermal conductivity compared to steel improve workability and efficiently transfer the heating and cooling provided by the press device (P) to the composite fabric 1, thus improving product quality and productivity.

The lower mold 10 and upper mold 20 mentioned above can be arranged in opposite directions depending on the working environment and molding conditions, and it is obvious that this falls within the scope of various modifications and equivalent embodiments that would be apparent to a person skilled in the art.

The process of manufacturing a shoe upper printed with a high-quality 3D three-dimensional design using a molding mold for a shoe upper of the present invention is as follows.

To achieve this, first, a composite fabric 1 be prepared. The composite fabric 1 refers to a foam package in which foam and textile are integrated into a single unit. For example, as shown in FIG. 3, the composite fabric 1 consists of: a first fabric made of textile with a thickness of 0.3 to 3.0 mm; a second fabric stacked on the upper surface of the first fabric, made of foam with a thickness of 1.0 to 10 mm; a third fabric stacked on the upper surface of the second fabric, made of textile with a thickness of 0.3 to 3.0 mm; and a printed layer coated onto the upper surface of the third fabric with a thickness of 0.02 to 2.0 mm.

The composite fabric 1 prepared in this way is prepared on the upper surface of the lower mold 10 as shown in FIGS. 1 and 2, and the upper mold 20 is covered to prepare for press molding. At this time, the guiding pins 23 of the upper mold 20 are inserted into the corresponding guiding grooves 13, of the lower mold 10, respectively, so that the recessed portions 12 of the lower mold 10 and the corresponding raised portions 22 of the upper mold 20, respectively, are accurately aligned as shown in FIG. 8.

In the molding process of the composite fabric 1 as described above, the fixing pin 15 firmly fixes the composite fabric 1, and compared to the composite fabric 1, which is molded in a state fixed to the lower mold 10 without the configuration of the fixing pin 15, the printing layer that is dyed and coated on the upper surface of the third fabric is molded without damage or distortion, and the desired upper shape can be realized.

This can be compared with the composite fabric formed with or without a fixing pin 15 in FIG. 9a and FIG. 9b, which shows the form in which the shoe upper is molded without a fixing pin, and FIG. 9b shows the form in which the shoe upper is formed by fixing it with a fixing pin 15.

In other words, in the case of FIG. 9a without the use of the fixing pin 15, it is observed that the printing layer color and design bend line of the composite fabric 1 that has been molded through the lower mold 10 and the upper mold 20 do not match the thickness step of the actual upper product, resulting in a large number of defects. On the other hand, in the case of FIG. 9b using the fixing pin 15, the printing layer color and the design dividing line of the composite fabric 1 that have been molded through the lower mold 10 and the upper mold 20 are accurately matched with the thickness step of the actual upper product at a 1:1 basis, resulting in a high-quality product shape. There is no problem with the implementation at all.

Next, the lower mold 10 and upper mold 20 that are aligned, stacked up, or engaged to each other as shown in FIG. 1 are placed on the lower die (b) of the press device (P) as shown in FIG. 1, and the molding mold (M) is pressed with the upper die (a), that is, the upper and lower sides of the upper and lower molds 10, 20 are pressed to form the shoe upper from the composite fabric 1.

In this invention, after the molding process is completed, surface treatments such as matte, semi-gloss, and glossy finishes can be performed through a post-processing step, and the lower mold 10 and the upper mold 20 may be subjected to a release coating treatment, such as Teflon coating, to improve the release properties from the shoe upper of the shoe during demolding.

The shoe upper molding mold of the present invention, configured as described above, allows for the formation of patterns and the application of various colors to the upper by simply placing a composite fabric between the lower and upper molds and applying pressure to the lower and the upper molds. This maximizes convenience and efficiency in the manufacturing process, enabling the mass production of high-quality shoe uppers in a short period of time.

Furthermore, unlike conventional methods that involve layering printing inks multiple times, this invention allows for precise molding of embossed, i.e., raised portion and debossed, i.e., recessed patterns, i.e., design, on the shoe upper material by applying pressure to the lower and upper molds. This results in sharp, well-defined edges of the patterns, maximizing the 3D effect on the shoe upper material. Simultaneously, the ability to apply various colors reduces the amount of printing ink required, significantly contributing to cost reduction in production.

Furthermore, the lower and upper molds are made of aluminum or epoxy resin, which reduces the weight and thus minimizes operator fatigue according to an aspect of the present invention. Additionally, because the molds can be precisely formed with both recessed and raised patterns, the edges of the upper shoe pattern remain sharp and clearly defined, maximizing or improving the 3D effect.

Furthermore, the molding mold for the shoe upper of the present invention can undergo surface treatment such as matte, semi-gloss, or glossy finishes through post-processing of the lower and upper molds after the molding process is completed. In addition, to improve the release properties between the upper and lower molds and the shoe upper during demolding, a release coating treatment such as Teflon coating can be applied, facilitating easy separation of the composite fabric from the upper and lower molds.

As described above, the shoe upper molding mold with improved molding quality using lower mold and upper mold interposed stopper therebetween, according to the present invention, has been exemplary described according to the embodiments shown in the drawings. However, it should be clearly understood that various modifications and equivalent alternative embodiments are possible to those skilled in the art. Therefore, the true technical scope of the present invention is defined by the matters described in the claims, and technical ideas within the equivalent scope should be interpreted as being included in the scope of the present invention.

[Explaining of symbols]

| | |
|---|---|
| 10: lower mold | 11: lower body |
| 12: recessed portion | 13: guiding groove |
| 15: fixing pin | 18: grip helping portion |
| 19: supporting part | 20: upper mold |
| 21: upper body | 22: raised portion |
| 23: guiding pin | 25: fixing groove |
| 100: stopper | 101: opening |

1. A shoe upper molding mold with improved molding quality using lower mold and upper mold interposed a plurality of stoppers therebetween, comprising:
a lower mold including a lower body with a predetermined length, width, and heights;
a composite fabric attached on the lower mold;
an upper mold including an upper body with a predetermined length, width, and heights; and
the plurality of stoppers configured to accommodate between the lower mold and the upper mold for maintaining a predetermined gap between the lower mold and the upper mold,
wherein the lower body includes recessed portions on the lower body with multiple grooves of predetermined shapes corresponding to the external shape and pattern of the shoe upper, and a plurality of guiding grooves formed on at positions adjacent to the edges of the lower body,
wherein an upper body includes a raised portions on the upper body with multiple protrusions, which corresponds to the recessed portions of the lower mold, and guiding pins protruding at positions corresponding to the guiding grooves of the lower mold, which are fitted into the guiding grooves of the lower body to align the lower mold, and is stacked on the upper surface of the lower mold to press the upper surface of the composite fabric,
wherein the plurality of stoppers is assembled to corresponding guiding pins formed on the upper mold, respectively, and a pressure applied to the composite fabric by the upper mold and the lower mold is based on the plurality of stoppers.

2. The shoe uppers molding mold of claim 1, wherein each the plurality of stoppers further comprises an opening on one side to facilitate engagement with the guiding pin.

3. The shoe uppers molding mold of claim 1, wherein the lower mold has a plurality of fixing pins for fixing the composite fabric to prevent it from moving, and the upper mold has fixing grooves at positions corresponding to the fixing pins.

4. The shoe upper molding mold of claim 3, wherein the number of fixing pins formed on the lower mold and the number of fixing grooves formed on the upper mold are in a range of 5 to 20, respectively.

5. The shoe upper molding mold of claim 1, wherein the fixing pin is conical in shape.

6. The shoe upper molding mold according to claim 1, further comprising: a grip helping portion are formed in an arched shape on both sides of the lower mold.

7. The shoe upper molding mold according to claim 1, wherein the material of the lower mold and the upper mold is composed of aluminum or epoxy resin for reduced manufacturing costs, lightweight properties, and improved thermal conductivity during molding.

8. The shoe uppers molding mold of claim 1, wherein the pressure applied to the composite fabric by the upper mold and the lower mold is adjusted based on the thickness of the plurality of stoppers.

9. The shoe uppers molding mold of claim 1, wherein the pressure applied to the composite fabric by the upper mold and the lower mold is adjusted based on the number of stoppers assembled to the corresponding plurality of guiding pins formed on the upper mold.
